(19) United States
(12) Patent Application Publication
(10) Pub. No.: US 2006/0266263 A1
(43) Pub. Date: Nov. 30, 2006

(54) Extremely fireproof inorganic foamed plastic body

(76) Inventor: Herbert Giesemann, Bonn (DE)

Correspondence Address: HARNESS, DICKEY & PIERCE, P.L.C., P.O. BOX 828, BLOOMFIELD HILLS, MI, 48303, US

(21) Appl. No.: 10/566,557

(22) PCT Filed: Jul. 28, 2004
(86) PCT No.: PCT/EP04/08493

§ 371 Date: Jun. 29, 2006

(30) Foreign Application Priority Data
Aug. 1, 2003 (DE) 103 35 232.5

(51) Int. Cl. C04B 28/26; B29C 65/00; C04B 12/04; C04B 35/16; C04B 38/00

(52) U.S. Cl. 106/601; 106/603; 264/43

(57) ABSTRACT

The invention relates to an extremely fireproof inorganic foam body, to a method for producing said body and to the use of the foam body.

The present invention relates to a highly refractory inorganic foam body, to a process for the preparation thereof, and to the use of such foam body.

Hardly ever did an event shake the civilized world as badly as that of Sep. 11, 2001, in New York. At this time at the latest, it was recognized that persons who occupy skyscrapers are exposed to fire catastrophes without any protection.

Both towers of the World Trade Center were erected from steel profiles about at the end of the 1980's. It is scarcely known that steel will lose its inherent strength and collapse in a temperature range of 750 to 800° C. Due to the kerosine cast into some stories from the aircrafts, the fire temperature was increased, The steel profiles did not withstand these temperatures.

For the first time, DE 39 23 284 C2 describes a thermal insulation material which demonstrably retains its volume for hours in a temperature range of 2100° C. to the flame temperature of a welding torch, This property is undoubtedly achieved by the mineral composition, quartz powder and sodium silicate, at a bulk density of 50 to 400 kg/m³. The low coefficient of thermal conductivity is caused by the presence of air cells. But despite of the large number of air cells with their very sensitive walls made of a fragile mineral material, suitable measures can be effected with the inventive product, for example, for achieving a sufficient abrasion resistance in the peripheral zones.

If some ammonium hydroxide is poured into an aqueous solution of an aluminum salt at room temperature, a jelly-like hydrogel of amorphous alumina will precipitate, which gradually converts to crystalline aluminum metahydroxide, AlO(OH). The jelly-like precipitate which is formed at first contains different amounts of water, which are in part absorbed and in part chemically bound. From such precipitates, stoichiometrically well-defined hydroxides can form gradually. In the past, it was assumed that the “aluminum oxide hydrates” formed (still referred to as alumina hydrates in industrial contexts) had the composition Al₂O₃.H₂O or Al₂O₃.3H₂O and thus were oxide hydrates. However, studies have shown that the precipitates are true hydroxides. From Römpp Chemielexikon, version 2.0, Stuttgart/New York: Georg Thieme Verlag, 1999, it is known to employ Al(OH)₃ itself in a finely dispersed form as a flame retardant.

The requirements to be met by highly refractory foam bodies can be summarized as follows:
1. absolute noninflammability;
2. sufficient mechanical strength;
3. as high as possible an insulating effect when the fire temperature passes to the side which is supposed to protect steel from at least 600° C.

In this field, thermal insulation materials are known, for example, for construction engineering, such as artificial resin foams, glass and mineral fibers and others.

These insulating materials are supposed, for example, to keep cold temperatures of −30° C. from a building or to keep the room temperatures from tropical temperatures of +40° C. Already above 100° C., artificial resin foams will burn vividly with smoke and poisonous gases, but they are nevertheless insulating materials,

Even the classical insulating material, mineral fiber, does not withstand fire temperatures of above 1000° C. on a long-term basis.

DE 199 09 077 A1 relates to a highly refractory inorganic foam body, to a process for the preparation thereof, and to the use of the foam body.

It is the object of the invention to develop novel foam bodies, especially fire-protection materials, which can protect from such temperature ranges for several hours, for example, from 4 to 6 hours, with high reliability.

It is a further object of the invention to additionally solve the problem of using lifts, especially passenger lifts, continuously for hours in the case of a fire.

In a first embodiment, the present invention relates to a highly refractory inorganic foam body consisting of a mixture which has at least partially open-cell structure and is foamed and cured by heating, which mixture consists of alkali water glass and aluminum hydroxide as well as one or more fillers selected from the group consisting of aluminum oxides, silicon oxides, alumina cement, powdered stone or mixtures thereof, having a bulk density within a range of from 200 to 900 kg/m³.

In this connection, “cooling” means the absorption of heat energy. For example, a plate of gypsum of 1 m² and 15 mm in thickness is supposed to contain 3 liters of water of crystallization. To evaporate this amount is supposed to absorb about 8400 kJ or 2000 kcal of energy.

Normally, gypsum has a coefficient of thermal conductivity of 2.1 W/mK. The evaporation causes a considerably reduction of the heat flow through the material.

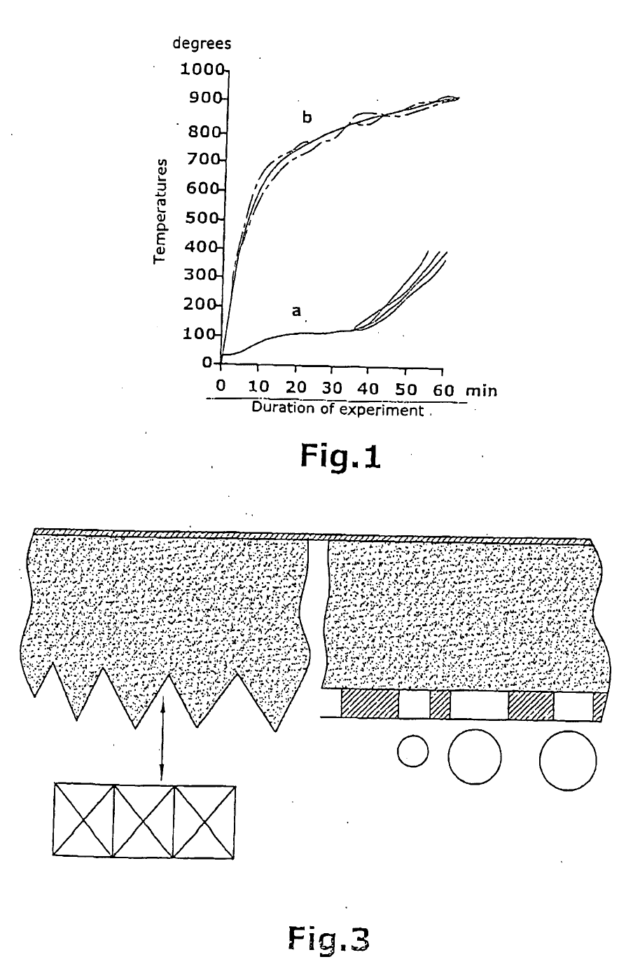

As illustrated in FIG. 1, test of such a compact gypsum plate (Kleinbrandschacht-test according to DIN 4102), it is found that the breakthrough of heat at about 100° C. is delayed by about 20 min, and curve b is the course of the standard temperature curve, referred to as “ETK” according to DIN 4102.

In the opinion of the gypsum plate industry, this cooling effect is based on this evaporation of the chemically bound molecule of water of crystallization.

However, curve a also shows that, after this 20 min of cooling effect, the curve goes steeply upwards, and after about 60 min, the temperature on the backside is around 400° C., i.e., far above the limit of 140° C. Such a plate would be rated as F 30.

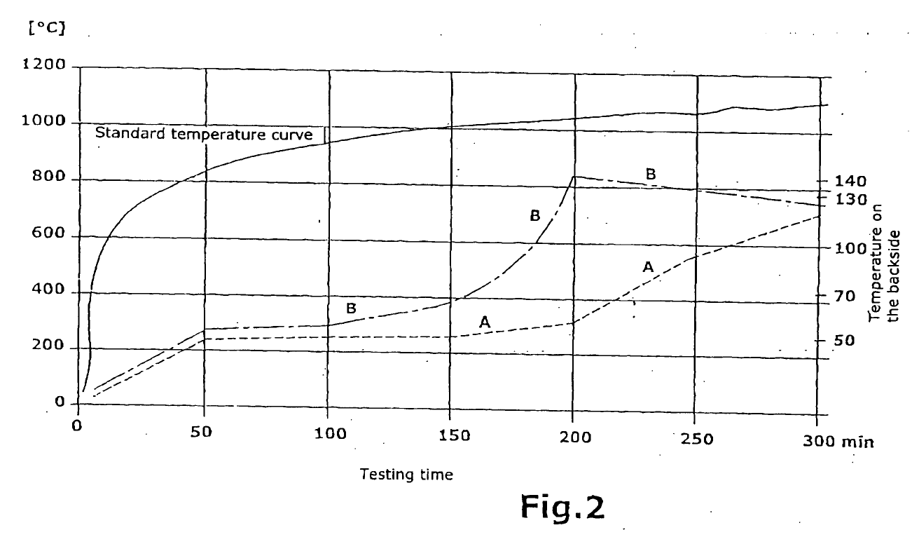

The result of such a test in a small fire oven according to DIN is totally different with the foam body according to the invention which contains chemically bound water molecules and, in particular, the aluminum hydroxide as an inorganic powder to the liquid glass: In FIG. 2, curve A shows the course with such a piece of foam having a thickness of 90 mm. After 300 min or 5 hours, a temperature of only 116° C. is achieved on the backside. However, the same foam plate, but with a thickness of 70 mm, reaches a limit temperature of 142° C. at the backside after 200 min of fire. Surprisingly, the temperature on the backside continuously decreases after this time, which is a great success of the cooling effect.

Thus, the optimum thickness of the foam insulation material according to the invention will be at 80 mm, with an expected result: peak after 250 min at 130° C., then continuously decreasing, which is the most impressive property of the material according to the invention.

In other tests with a propane gas flame, it was found that these results are very similar for bulk densities of from 200 kg/m³ to 900 kg/m³.

Surprisingly, it has now been found that free as well as chemically bound water molecules in equal amounts are present also in the above mineral foam insulating material according to the invention, The free water molecules evaporate at room temperature, and at a higher rate as in DE 39 23 284 C2 at temperatures of, for example, 100° C. to 200° C. According to former experience, the cooling effect according to the invention is obtained when the molecules of the water of crystallization evaporate, i.e., only in a range of about 500 to 700° C.

This surprisingly favorable result is not only due to the cooling effect of the water of crystallization of the sodium silicate, but also due to the cooling effect of the aluminum hydroxide and the cooling effect from the evaporation of the hydroxide fraction of this mineral.

The progress over DE 39 23 284 C2 resides in the fact that, according to the invention, the cooling effect from the evaporation of the water of crystallization at high fire temperatures has been recognized and employed reasonably, but also in the second step by employing the aluminum hydroxide for enhancing the evaporation effect of the water molecules.

In the practice of the use of such foam bodies, especially as fire-protection materials, for example, in the construction of skyscrapers, these lining and coating materials must meet minimum requirements, which include, for example, an unobjectionable appearance, a high shock resistance and/or scratch resistance when steel supports in rooms are lined with those materials.

In Germany, the DIN standard 4102 sets further important demands on the mechanical strengths: The fire-protection lining must withstand a water-jet pressure of 2 bar for 1 min (item 6.2.10).

The densification of peripheral zones as mentioned in some detail in DE 39 23 284 C2 including the tensile strength reinforcement also has an important function according to the invention. It is the concept of bionics, as with a human or animal bone: light-weight inside, and greatest hardness outside.

Such a bionic design of a noninflammable insulation material is not possible in other noninflammable materials, such as calcium silicate and gypsum plates, already because of the two factors of complete lacking of air cells as well as the lacking of tensile strength reinforcements. The intumescent chemicals which are occasionally employed do not have a mechanical surface hardness either.

All requirements as fire protection for the lining of steel and reinforced concrete constructions are met by the innovative developments of materials as described.

All fire-protection materials according to the invention contains sodium/potassium silicates as binders. They bring about a quite substantial advantage when used for steel and reinforced concrete linings in practice: The silicate solutions are the only inorganic refractory adhesive. Thus, their application, for example, to steel surfaces is particularly simple and efficient in handling. The steel side receives a coating of a mixture of mineral powder (aluminum hydroxide) and sodium silicate, as does the surface of the inventive fire-protection plate to be inserted. Such an application, for example, below a steel sheet ceiling, adheres immediately in this way and need not be supported,

The foam bodies according to the invention, for example, fire-protection plates, at the same time have an excellent absorption of air-borne sound. An efficient absorption of the existing air-borne sound waves is already a consequence of the mineral open-cell structure. This effect can be achieved, for example, by a refractory perforated plate or by machining the surface to form small pyramids, as shown in FIG. 3.

In contrast to windows, doors and fire doors can be standardized in dimensions.

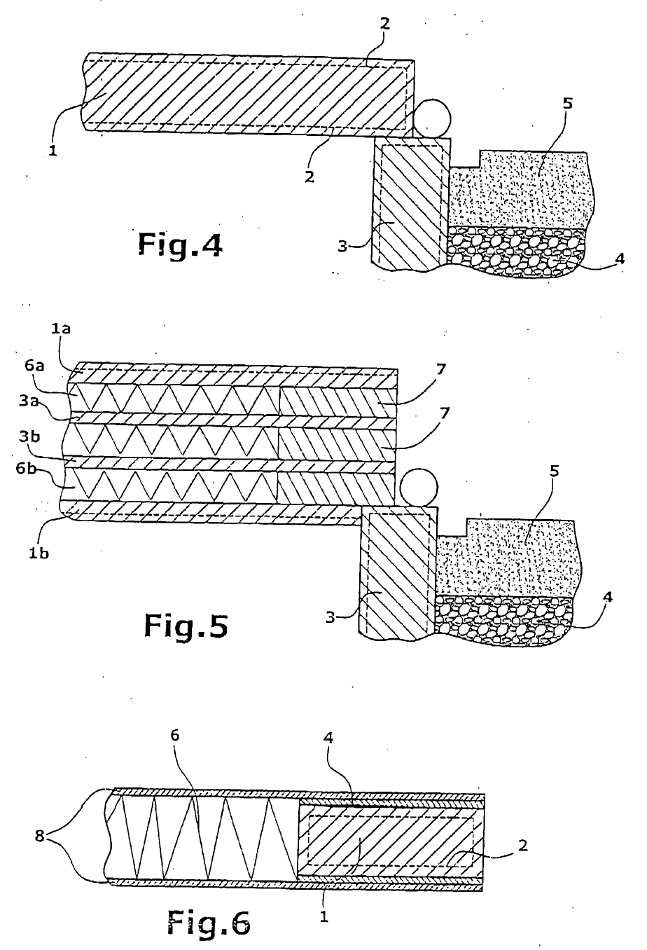

In FIG. 4, the construction of a general-purpose noninflammable and highly refractory interior and exterior door is described. But the foam material according to the invention not only has a cooling effect in the case of a fire, but it is additionlly completely waterproof and water vapor proof for wet rooms, shock and scratch resistant, veneerable on both sides, glazable and bullet-proof.

The compact door leaf 1 consists of the foam material according to the invention which contains a reinforcement 2 providing tensile strength in bending. The frame 3 has the same properties as the door leaf 1 (because of its fire behavior, heat conductivity etc., this is more favorable than the steel profile which is mostly employed here). The brickwork 4 and the interior plaster 5 are also shown.

A special construction for a fire door according to the invention instead of a door made of steel sheet is illustrated in FIG. 5. The two thin mineral interior plates 3a, 3b made of the foam bodies according to the invention provide cooling. The particular effect for a high efficiency preventing the passage of heat is seen in the fact that the water molecules penetrate into the mineral fiber zones and further absorb heat energy by the cooling in these fiber zones during the evaporation.

The outer shaping composite plates according to the invention 1a, 1b having a cooling effect are welded to frame plates 7 (1 to 1.5 mm) in pyramid shape. Mineral fiber plates 6a, 6b are respectively provided between two layers of the foam bodies according to the invention. The reference symbols 4, 5 and 6 have the same meanings as in FIG. 6. The production of fire-protection linings is a particularly important field of the present invention, especially the fire protection of steel and reinforced concrete supports in rooms. In particular, the surface of these linings must be mechanically strong in this case to resist the pressure of the jet of fire-fighting water hitting the surfaces with 2 bar.

The application examples show that steel ceilings and steel profiles with the fire-protection materials according to the invention withstand temperatures of from 1050 to 1200° C. for a period of from 4 to 6 hours depending on their thickness, because they can withstand up to 2100° C., the temperature of a welding torch, while exhibiting the important cooling effect.

At any rate, the highest safety levels are reached by the use and the constructive design of the fire-protection insulation materials according to the invention in these and other constructive designs. According to the invention, a high safety level in the construction and reconstruction of skyscrapers is possible with the use of the fire-protection materials according to the invention and their appropriate use in usual wall thicknesses.

All tower blocks, skyscrapers or similar buildings have stairwells, especially emergency stairwells, for cases of fire in order that persons may get into the open.

But even if a tower block has several emergency stairwells, it appears unreasonable that each person can descend, for example, 100 stories in a staircase, and that further these thousands of people could find enough space to walk in a stairwell.

Thus, the most important problem is seen in the fact that lifts, especially passenger lifts, cannot be used without a time limit, also in the case of a fire.

Lifts always move within a lift shaft, and since weak-current lines are accommodated in this shaft, inter alia, a temperature of 60° C. should not be exceeded in the shaft in the case of a fire. Consequently, the whole shaft, which runs through all stories, must be coated with thermal insulation materials in such a way that 60° C. in the interior is not exceeded.

The coating with highly refractory insulation materials from all sides of the lift shafts is achieved in an excellently reliable way by the foam material according to the invention. This is currently not possible with any other insulation material worldwide.

The greatest obstacle in the object of using lifts always, even in a case of fire, is the doors in all stories which are always opened as sliding doors for entering the lift shafts. In practice, these sliding doors are prepared from steel sheet, also from stainless steel sheet. Now, steel has an unfavorable coefficient of thermal conductivity of from 45 to 70 W/mK, depending on the alloy. When a fire starts, this means that the sliding doors conduct the heat of the fire relatively quickly to the backside of the door. Nothing changes in this physical effect if the metal sheet construction is filled inside with a thermal insulation material, such as mineral fibers, much like the fire doors in tower blocks.

In addition, when there is a fire in one story, flue gases as well as toxic gases develop immediately, mostly from the burning plastic materials. However, slide doors must be moved continuously, i.e., they can never close to form a smoke- and gas-tight seal towards the lift shaft. In addition, each lift cage causes a strongly reduced pressure in the shaft when moving downwards or upwards; thus, smoke would be taken in more strongly. As a result, such a construction of easily movable slide doors can never be sealed to be smoke-tight in the case of a fire.

A possible construction for highly refractory sealing doors in the story and in the lift cages is shown in FIG. 6, where the composite material according to the invention gave a value of, for example, F 120 in the test for the frame represented here in a thickness of 18 mm.

The mineral composite material 1 according to the invention which has a cooling effect includes a tensile reinforcement 2. The stainless steel sheets 8 are welded onto the frame of the composite material with the sodium silicate.

The proposition shown in FIG. 6 has the following advantages:
(1) By replacing the steel frame by the composite material with a coefficient of thermal conductivity of 1.2 W/mK, the fire temperature is conducted to the backside in a highly delayed manner.
(2) By replacing the mineral fiber by a mineral foam insulation material having a cooling effect, i.e., a value of F 120, the passage of the heat radiation is avoided almost completely.

However, an air gap can hardly be avoided with these slide doors. It must be about 2 mm wide.

The manufacturers of the lifts are usually of the opinion that steel or stainless steel sheets must be employed as the surfaces of such doors, at least where they come into contact with the persons.

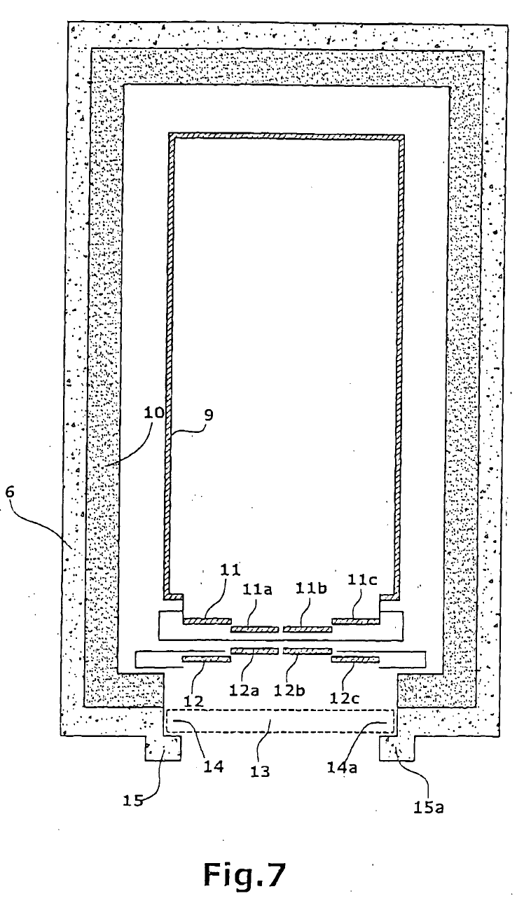

According to the invention, a new solution to this heat and flue gas problem is presented as shown in FIG. 7. In the case of a story fire, heat and/or smoke sensors trigger the lowering of a door-like shaped body prepared from the heat protection materials according to the invention. As shown in FIG. 7, both problems have been solved optimally with this construction and the materials according to the invention: a complete blocking of the passage of heat for many hours as well as a complete flue gas tightness at all peripheral zones of this fire-protection insulation body, vertically as well as horizontally.

FIG. 7 shows a lift according to the invention. A usual lift cage 9 of steel is provided within a usual raw construction 10 of steel or reinforced concrete. The lining of this constructive wall with noninflammable thermal insulation materials according to the present invention ensures in the case of a fire that the interior temperature of the lift shaft passing through does not exceed a temperature of 50 to 60° C. even after several hours. The inner slide doors 11, 11a, 11b and 11c of the lift cage limit the lift shaft inwardly, while the slide doors 12, 12a, 12b and 12c on the story side seal the shaft towards the building.

The fire protection seal according to the invention is formed by the highly refractory inorganic foam bodies according to the present invention. It is optionally adjusted by sensors in the case of a fire. The lateral smoke-tight ports 14, 14a are optionally pressed against the mechanical guides by thin steel sheets 15, 15a.

The progress primarily resides in the fact that, in contrast to the slide doors which are always flexible, this safety construction against heat, smoke and all gases is employed automatically only in the case of a fire and thus provides a maximum of safety, and secondarily, that fire protection insulation materials which achieve an optimum of protective effect, for example, due to the cooling effect have been developed simultaneously for this inventive construction. Thirdly, there is an advantage in that this constructional idea can be realized at any time in existing skyscrapers without disturbing the daily operation of the lifts. For the reasons mentioned above, a substitution of the existing doors by some other smoke-tight construction could not be realized anyway.

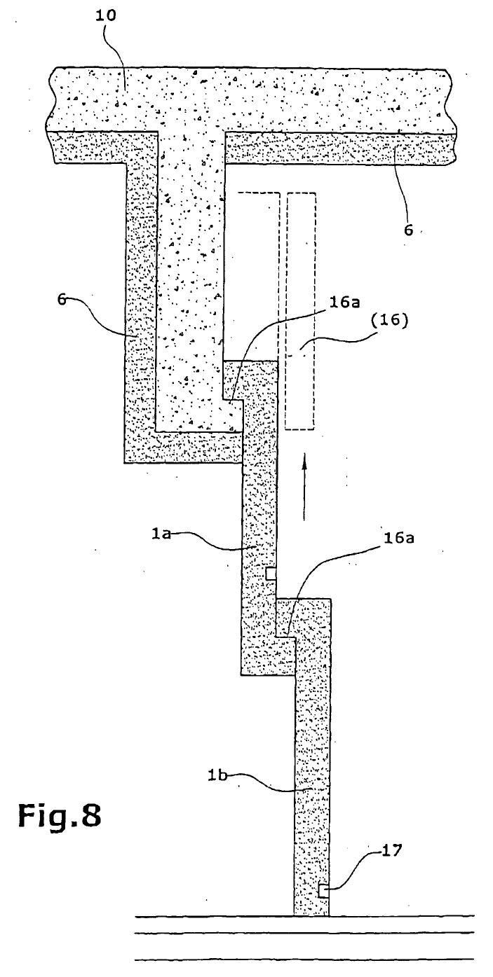

FIG. 8 illustrates a variant of the above mentioned constructional idea.

A raw construction 10 of a lift shaft is thermally protected at the ceiling sufficiently by a thermal and flameproof lining 6. Triggered by a smoke and/or temperature sensor, the fire- and gastight sealing body 1, 1a, 1b, which is sealed in a completely smoke-tight way at 16a and 16b already by its proper weight, is lowered. A gap-like opening 17 for inserting a handy object ensures that the body can be pushed upwards, for example, if the fire fighters want to get at the source of the fire with hoses.

This proposition according to the invention is of particular importance since it is the task of the fire fighters to get at the source of the fire for extinction as quickly as possible after a fire has started. Carrying hoses upwards through stairwells is almost unacceptable. Therefore, it is proposed: to pass water ascending pipes upwards through the cool and fire-resistant lift shafts to be connected to short hoses in each story.

Thus, in the case of a fire, the fire fighters could successfully fight the local source of fire with the water jet within a very short time after entering a skyscraper.

In tower blocks and skyscrapers, the entrance halls in which the passenger lifts end mostly have room heights of above 4.0 m. Here, it is possible to provide the shaped body according to the invention against fire heat and flue gases in a one-piece design, while such a multistep design can be provided for a room height of less than 3.10 m.

The interior doors in tower block buildings, especially for use as offices, towards the corridors, which are the escape routes leading to the staircases or lifts, are prepared from wood materials.

Now, cellulose is known to ignite already at above 150° C., and according to DIN 4102, this temperature is exceeded already after 1 min of fire in the room.

Thus, the door leading to the corridor quickly catches fire, and the smoke drifts into the escape route. If this room is near the emergency stairwell, the persons who want to flee from the other rooms are hindered or poisoned by the smoke zone within the escape corridor.

Therefore, it is proposed, at least for newly constructed skyscrapers, to design such doors to be not only noninflammable, but also highly refractory in F30 to F60. If at least the door leaf of such a door is prepared in standard sizes, this is not only ecologically appropriate, but can also be realized under economic aspects.

With the aid of the idea according to the invention, the second weak point in the room in the case of a fire, which is the window construction, can also be protected reliably in the same way, because the flames will leap upwards. After a fire curtain made of the foam body according to the invention has been lowered, not only is the fire localized, but the particularly dangerous fire propagation into the higher floors is also reliably and efficiently avoided.

It is sure that a maximum level of safety for all persons in tower blocks and skyscrapers is achieved through the development of the highly refractory materials, especially due to the cooling effect in connection with these materials.

In a further preferred embodiment of the present invention, the foam body is characterized by containing aluminum hydroxide in an amount of from 60 to 80% by weight and having a mixed composition of powder dimensions (multimodal grain size distribution).

If the amount of aluminum hydroxide powder is chosen lower, the mineral mixture has a lower compressive strength. In contrast, if the amount of aluminum hydroxide is chosen too high, the mineral mixture lacks the liquid glass as an inherent adhesive.

Another embodiment of the present invention consists in a process for the preparation of the above mentioned foam bodies by adding a blowing agent to a mixture of alkali water glass and optionally a filler selected from the group consisting of aluminum oxides, silicon oxides, alumina cement, powdered stone or mixtures thereof, which further contains aluminum hydroxide, and heating at a temperature within a range of from 200 to 300° C.

It is particularly preferred within the meaning of the present invention to employ azodicarbonamide as the blowing agent.

A further embodiment of the present invention consists in the use of the above mentioned foam bodies for the preparation of refractory building elements in civil and constructional engineering.

It is particularly preferred within the meaning of the present invention to use the foam bodies according to the invention for the fire- and smoke-tight sealing of lift shafts or lift doors. In the same way, it is also possible to produce and to use fire doors, fire-protection linings, data protection safes and rooms, floppy-disk inserts, attachments, fire protection seals, cable and tube end seals, smoke extraction flaps, fire curtains and the like.

1. A highly refractory inorganic foam body which has an at least partially open-cell structure and is foamed and cured by heating, said body being formed from a mixture comprising alkali water glass and aluminum hydroxide as well as one or more fillers, said body having a bulk density within a range of from 200 to 900 kg/m³.

2. The foam body according to claim 1, wherein said aluminum hydroxide is present in an amount of from 60 to 80% by weight.

3. A process for the preparation of a foam body according to claim 1, in which a blowing agent is added to said mixture prior to heating.

4. The process according to claim 3, characterized in that azodicarbonamide is employed as the blowing agent.

5. Use of a foam body according to claim 1 for the preparation of refractory building elements.

6. The use according to claim 5 wherein said refractory building elements include fire doors and fire-protection linings.

7. The foam body according to claim 1 wherein said one or more fillers are selected from the group consisting of aluminum oxides, silicon oxides, alumina cement, powdered stone or mixtures thereof.

8. The process of claim 3 wherein said mixture is heated to a temperature within the range of 200 to 300° C.

9. The use according to claim 5 wherein said fire doors include lift doors.

10. The use according to claim 5 wherein said fire protection linings include lift shaft linings.

11. A highly refractory inorganic foam body which has at least partially open-cell structure and is foamed and cured by heating, said body being formed from a mixture comprising alkali water glass and aluminum hydroxide, at least one blowing agent and one or more fillers selected from the group consisting of aluminum oxides, silicon oxides, alumina cement, powdered stone or mixtures thereof, said body having a bulk density within a range of from 200 to 900 kg/m³.

12. The foam body according to claim 11, wherein said aluminum hydroxide is present in an amount of from 60 to 80% by weight.

13. The process according to claim 11 characterized in that azodicarbonamide is employed as the blowing agent.

14. Use of a foam body according to claim 11 for the preparation of refractory building elements.

15. The use according to claim 14 wherein said refractory building elements include fire doors and fire-protection linings.

16. The process of claim 11 wherein said mixture is heated to a temperature within the range of 200 to 300° C.

17. The use according to claim 14 wherein said fire doors include lift doors.

18. The use according to claim 14 wherein said fire protection linings include lift shaft linings.
